(19) United States
(12) Patent Application Publication
(10) Pub. No.: US 2021/0388851 A1
(43) Pub. Date: Dec. 16, 2021

(54) ELECTRIC PUMP

(71) Applicant: AISIN CORPORATION, Kariya (JP)

(72) Inventors: Mitsuru IKEDA, Kariya-shi (JP); Shinsuke ISOGAI, Kariya-shi (JP); Shuji HATTORI, Kariya-shi (JP)

(73) Assignee: AISIN CORPORATION, Kariya (JP)

(21) Appl. No.: 17/326,998

(22) Filed: May 21, 2021

(30) Foreign Application Priority Data
Jun. 16, 2020 (JP) 2020-103699

(51) Int. Cl. F04D 29/58; F04D 13/06; F04C 11/00

(52) U.S. Cl. CPC F04D 29/5813; F04C 2240/30; F04C 11/008; F04D 13/0686

(57) ABSTRACT

An electric pump includes a housing having a bottom portion and an opening portion provided at an opposite side to the bottom portion, a motor rotor rotatably accommodated in the housing, a field coil, a pump rotor configured to transmit fluid by being rotated by a driving force of the motor rotor, and a control substrate provided at an outside of the bottom portion. The bottom portion includes a heat conduction wall formed of material including heat conductivity which is higher than heat conductivity of the housing. The housing includes a space portion formed with a flow path configured to allow the fluid to flow into the space portion and flow out of the space portion after the fluid is in contact with an inner surface of the heat conduction wall.

### CROSS REFERENCE TO RELATED APPLICATIONS

This application is based on and claims priority under 35 U.S.C. § 119 to Japanese Patent Application 2020-103699, filed on Jun. 16, 2020, the entire content of which is incorporated herein by reference.

### TECHNICAL FIELD

This disclosure generally relates to an electric pump.

### BACKGROUND DISCUSSION

A known electric pump (for example, which is disclosed in JP2001-193683A which will be hereinafter referred to as Patent reference 1) includes an annular stator in a housing, the stator including winding. The known electric pump includes a rotor which includes a permanent magnet and is rotatably arranged in an inner space portion of the stator. The known electric pump includes a pump rotor (an impeller in the Patent reference 1) driven by the rotor. The known electric pump includes a control substrate (a drive circuit substrate in Patent reference 1) controlling an electric current to be supplied to a field coil and provided in the housing.

The electric pump of Patent reference 1 (a fluid pump apparatus in Patent reference 1) includes a can including a bottomed cylindrical shape and provided at an inner portion of the stator, and the rotor is rotatably arranged at an inner side of the can. The control substrate is arranged at an end portion (a position that is at a side opposite to the pump rotor in a direction along a rotation axis of the rotor) of the stator, and a heat release sheet is sandwiched between a power transistor of the control substrate and a bottom portion of the can. In this configuration, material which is high in heat conductivity and includes elasticity is used for the heat release sheet.

The electric pump of Patent reference 1 is configured such that fluid from a pump rotor-side comes into a gap of the rotor and the can, and heat of the power transistor is transferred to the bottom portion of the can via the heat release sheet, and accordingly heat release is performed by the fluid.

As described in Patent reference 1, the configuration, in which part of the fluid from the pump rotor flows in the inner portion of the can and the heat of the electric power transistor is transmitted via the heat release sheet provided at the bottom portion of the can enables a favorable heat release compared to heat release using air convection, for example.

The configuration of Patent reference 1, however, needs a high accuracy in assuring the gap for the can to be arranged between the stator and the rotor. Because the gap is made large for the can to be arranged, magnetic flux density that is applied from the winding of the stator to the rotor may decrease, thereby leading decrease in a performance of the electric motor.

A need thus exists for an electric pump which is not susceptible to the drawback mentioned above.

### SUMMARY

According to an aspect of this disclosure, an electric pump includes a housing including a bottomed cylindrical shape having a bottom portion and an opening portion provided at an opposite side to the bottom portion, a motor rotor rotatably accommodated in the housing and including a permanent magnet, a field coil formed integrally with the housing and configured to apply a magnetic field to the permanent magnet, a pump rotor provided at an outside of the opening portion of the housing and configured to transmit fluid by being rotated by a driving force of the motor rotor, and a control substrate provided at an outside of the bottom portion of the housing and configured to control an electric current to be supplied to the field coil. The bottom portion includes a heat conduction wall formed of material including heat conductivity which is higher than heat conductivity of the housing. The housing includes a space portion in which the motor rotor is accommodated. The space portion is formed with a flow path configured to allow the fluid to flow into the space portion from the opening portion, and allow the fluid to flow out of the space portion from the opening portion after the fluid is in contact with an inner surface of the heat conduction wall. The control substrate is arranged to be positioned along an outer surface of the heat conduction wall.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view of a water pump according to an embodiment disclosed here;

FIG. 2 is an enlarged cross-sectional view illustrating a flow path according to the embodiment;

FIG. 3 is a cross-sectional view of a water pump according to another embodiment (a) disclosed here;

FIG. 4 is a cross-sectional view taken along line IV-IV in FIG. 3; and

FIG. 5 is a cross-sectional view of a cylindrical body and a shaft according to still another embodiment (b) disclosed here.

### DETAILED DESCRIPTION

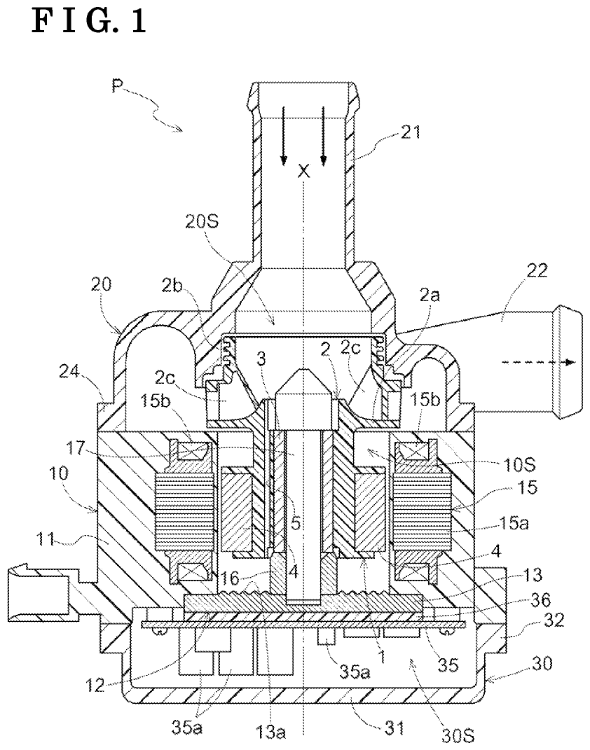

An embodiment disclosed here will be described hereunder with reference to the drawings. A basic configuration of the disclosure will be described. FIG. 1 illustrates a water pump P (i.e., an electric pump) allowing cooling water (i.e., fluid) between an engine and a radiator.

As illustrated in FIG. 1, the water pump P includes a housing structure configured by a main housing 10, a pump housing 20 and a control housing 30 which are connected to one another in a direction along an axis X. The main housing 10 includes a bottomed cylindrical shape or a cylindrical shape with a closed end, and accommodates therein a motor rotor 1. The pump housing 20 accommodates therein a pump rotor 2. The control housing 30 accommodates therein a control substrate 35.

The water pump P is configured by the motor rotor 1 and the pump rotor 2 which are formed of resin to be integral with each other. The pump rotor 2 rotates about the axis X in association with the driving of the motor rotor 1. Due to the above-described configuration, the cooling water is suctioned or taken in from an intake cylinder 21 of the pump housing 20 and the suctioned cooling water is discharged from a discharge cylinder 22 of the pump housing 20, as the pump rotor 2 is driven and rotated. The water pump P includes a heat release configuration in which heat generated at an electric power control element 35a of the control substrate 35 when the motor rotor 1 is driven is released with the use of the cooling water that has flowed into a motor rotor space portion 10S (i.e., a space portion) of the main housing 10.

The main housing will be described. The main housing 10 (i.e., a housing) includes a wall portion 11 having a cylindrical shape of which the center is the axis X, and a bottom portion 12 arranged to be orthogonal to the axis X. The main housing 10 includes the motor rotor space portion 10S formed in a region surrounded by the wall portion 11 and the bottom portion 12. The motor rotor space portion 10S includes an opening portion provided at a side opposite to the bottom portion 12. The wall portion 11 is made of resin. The bottom portion 12 includes a configuration in which a heat conduction wall 13 formed of plate material including, for example, aluminum material having a higher heat conductivity than the resin is fixed to a bottom surface of the wall portion 11 with a technique of inserting and/or welding.

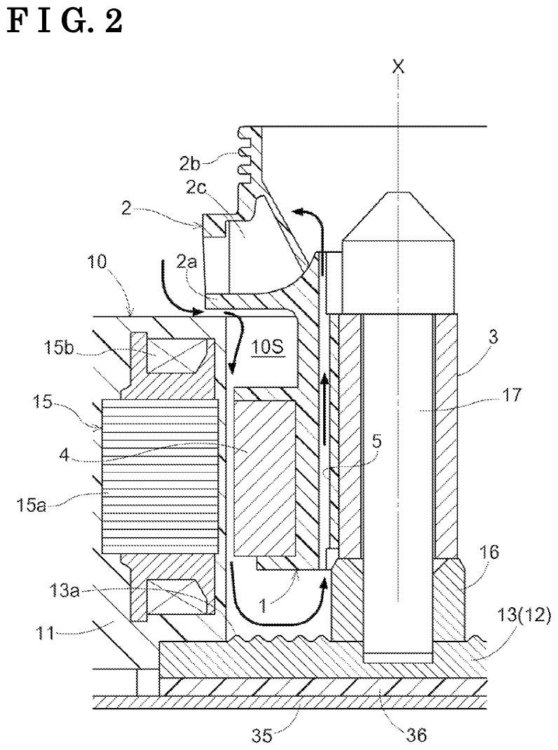

A field coil 15 at which a conductor wire 15b is wound on a core 15a and which serves as a stator is arranged at an inner circumferential side of the wall portion 11 and is formed to be integral with the wall portion 11 by insert molding. The heat conduction wall 13 includes a support portion 16 provided at an inner surface (an upper surface in each of FIGS. 1 and 2) of the heat conduction wall 13, and an end portion of a shaft 17 is supported at the support portion 16 such that the shaft 17 is coaxial with the axis X.

The support portion 16 and the shaft 17 are made of metal. The support portion 16 may be formed integrally with the heat conduction wall 13 or may be fixed to the heat conduction wall 13 with, for example, a nut.

As illustrated in FIGS. 1 and 2, a cylindrical body 3 made of material including a low sliding resistance relative to a rotational center portion of the motor rotor 1 and the pump rotor 2 is provided. The cylindrical body 3 is externally fitted to the shaft 17 to be rotatable relative to the shaft 17, and accordingly the motor rotor 1 and the pump rotor 2 are rotatably supported at the shaft 17. Plural permanent magnets 4 are fixed to an outer periphery of the motor rotor 1. The motor rotor 1 and the pump rotor 2 are formed with a water transmitting hole 5 arranged in a region from the motor rotor 1 to the pump rotor 2 so as to follow a lengthwise direction or longitudinal direction of the cylindrical body 3.

The water transmitting hole 5 is formed to penetrate from a position which is at the motor rotor 1 and is close to the heat conduction wall 13 to a position which is at the pump rotor 2 and at which an impeller 2c is formed. According to the above-described configuration, a portion at which the impeller 2c is arranged becomes a negative pressure when the pump rotor 2 rotates, and accordingly the cooling water of the motor rotor space portion 10S flows out from the water transmitting hole 5 and the cooling water flows into the motor rotor space portion 10S from the opening portion of the main housing 10, as shown in FIG. 2 where the arrows indicate the flows. Plural water transmitting holes 5 may be provided

The water pump P includes a clearance provided between an outer periphery of a disk portion 2a of the pump rotor 2 and the opening portion of the main housing 1, and the clearance allows the cooling water to flow therethrough. The above-described clearance, a gap formed in the motor rotor space portion 10S between an outer peripheral side of the motor rotor 1 and an inner peripheral side of the wall portion 11, and the water transmitting hole 5 configure a flow path through which the cooling water circulates and flows to the pump rotor 2. According to the water pump P, the motor rotor 1 including the plural permanent magnets 4, and the field coil 15 provided at the wall portion 11 of the main housing 10 configure a brushless DC motor of a three-phase motor type.

The pump housing of the disclosure will be described. The pump housing 20 is provided with a pump space portion 20S including a circular shape of which the center is the axis X so that the pump rotor 2 is accommodated in the pump space portion 20S. The pump housing 20 includes the intake cylinder 21 formed to be coaxial with the axis X and being in fluid communication with the pump space portion 20S. The pump housing 20 includes the discharge cylinder 22 being in fluid communication with the pump space portion 20S in a tangential direction.

A pump flange portion 24 of the pump housing 20 is connected to the main housing 10, and thus the pump housing 20 is integrated with the main housing 10.

The pump rotor 2 includes the disk portion 2a including a disk shape arranged to be orthogonal with the axis X, a shroud 2b positioned to face or oppose the disk portion 2a, and plural impellers 2c provided between the disk portion 2a and the shroud 2b. A diameter of the disk portion 2a is set at a value that is slightly larger than an inner diameter of the main housing 10.

The control housing will be described. The control housing 30 is a resin molding in which a case flange portion 32 is formed integrally with an opening section of a case-shaped portion 31 including a bowl shape as a whole. A substrate accommodation space 30S is formed inside the case-shaped portion 31. The case flange portion 32 is connected to the main housing 10, and accordingly the control housing 30 is integrated with the main housing 10 and the substrate accommodation space 30S of the control housing 30 is maintained in a sealed state.

The control housing 30 accommodates the control substrate 35 in the substrate accommodation space 30S. The control substrate 35 includes the electric power control element 35a provided at one substrate surface of the control substrate 35. The electric power control element 35a controls electric power to be supplied to the field coil 15.

The control substrate 35 is arranged in such a posture that the other substrate surface (i.e., a facing surface) of the control substrate 35 which is not provided with, for example, the electric power control element 35a is arranged to follow along the heat conduction wall 13. That is, the other substrate surface of the control substrate 35 is flat or even and an outer surface (i.e., a facing surface) of the heat conduction wall 13 (a lower surface in each of FIGS. 1 and 2) facing the other substrate surface of the control substrate 35 is also flat or even. By arranging the other substrate surface of the control substrate 35 and the outer surface of the heat conduction wall 13 to be parallel with each other, a heat release sheet 36 including a constant thickness is allowed to be sandwiched between the surfaces.

The heat release sheet 36 includes flexibility and is able to deform flexibly. The heat release sheet 36 includes a sheet shape and is formed of resin material which is high in heat conductivity. The heat release sheet 36 is sandwiched or interposed between the control substrate 35 and the heat conduction wall 13, and thus a high heat conductivity is allowed via the surfaces that are in close contact with each other without any gap generated therebetween. In particular, the heat release sheet 36 includes a higher heat conductivity than the resin forming the main housing 10, and accordingly the heat release sheet 36 transfers heat of the control substrate 35 to the heat conduction wall 13 via the heat release sheet 36.

The heat release configuration of the embodiment will be described. As illustrated in FIGS. 1 and 2, the heat release configuration is formed of the heat conduction wall 13, the heat release sheet 36 and the flow path by which the cooling water is sent to the heat conduction wall 13. According to the heat release configuration, the heat generated at, for example, the electric power control element of the control substrate 35 is cooled down with the cooling water that has been taken in the motor rotor space portion 10S of the main housing 10 as illustrated in FIGS. 1 and 2.

That is, the heat conduction wall 13 is arranged at a boundary position between the motor rotor space portion 10S of the main housing 10 and the substrate accommodation space 30S of the control housing 30. Thus, an inner surface of the heat conduction wall 13 is exposed to the motor rotor space portion 10S and the outer surface of the heat conduction wall 13 is arranged at a side facing the substrate accommodation space 30S. The flexible heat release sheet 36 allowing the heat conduction is sandwiched between the outer surface of the heat conduction wall 13 and the control substrate 35, and accordingly the heat release sheet 36 is in contact with the outer surface of the heat conduction wall 13 and with the control substrate 35 at a large surface or area, thereby realizing an effective heat conduction of the heat generated at the control substrate 35.

The heat conduction wall 13 includes plural protrusion-and-recess portions 13a provided at the inner surface disposed to the motor rotor space portion 10S, and thus increasing a contact area at which the heat conduction wall 13 is in contact with the cooling water. The protrusion-and-recess portions 13a are not limited to a simple protrusion-and-recess surface or simple uneven surface, and may include a configuration in which plural protrusions protrude from the inner surface of the heat conduction wall 13, for example. The protrusion-and-recess portions 13a may be formed as a fin or fins formed linearly or wavily when viewed in a direction along the axis X, for example.

According to the above-described configuration, a region of the pump rotor 2 around the impellers 2c becomes the negative pressure as the pump rotor 2 rotates, and the water transmitting hole 5 allows the cooling water of the motor rotor space portion 10S to flow in a direction towards the impellers 2c as illustrated in FIG. 2. The cooling water from the pump rotor 2 flows in the flow path that corresponds to the gap formed by the inner peripheral side of the wall portion 11 of the motor rotor space portion 10S of the main housing 10 and the outer peripheral side of the motor rotor 1, and then comes in contact with the protrusion-and-recess portions 13a of the heat conduction wall 13. The cooling water then removes the heat of the heat conduction wall 13 and flows to the pump rotor 2 via the water transmitting hole 5 in a circulating manner, thereby allowing the heat release of the control substrate 35 with the use of the heat conduction wall 13. As described above, the water pump P of the embodiment utilizes effectiveness of enabling the heat release of the control substrate 35 with the use of the cooling water flowing from the pump rotor 2 to the inside of the main housing 10, and thus is highly efficient.

Other embodiments of the disclosure will be described. The present disclosure may be configured as follows instead of the aforementioned embodiment (the same reference numeral and/or reference character is given to the function or configuration same as the aforementioned embodiment in the embodiments).

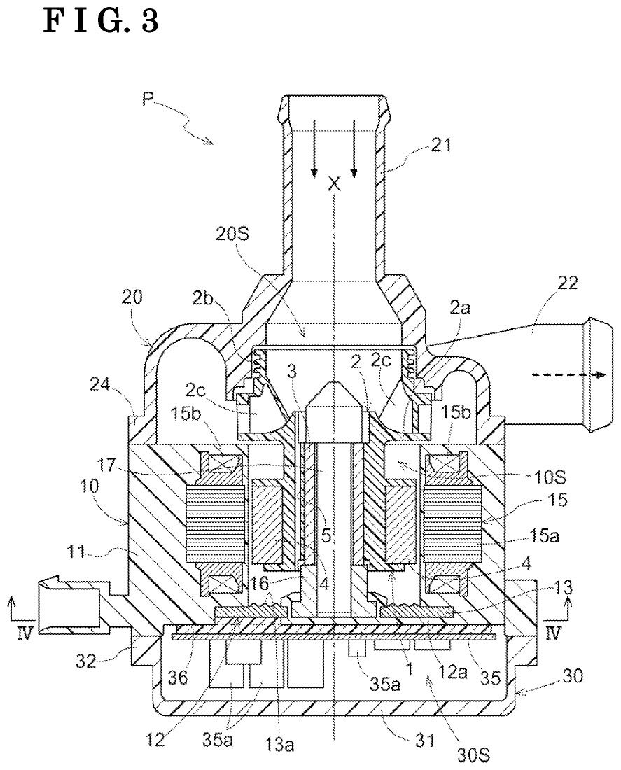

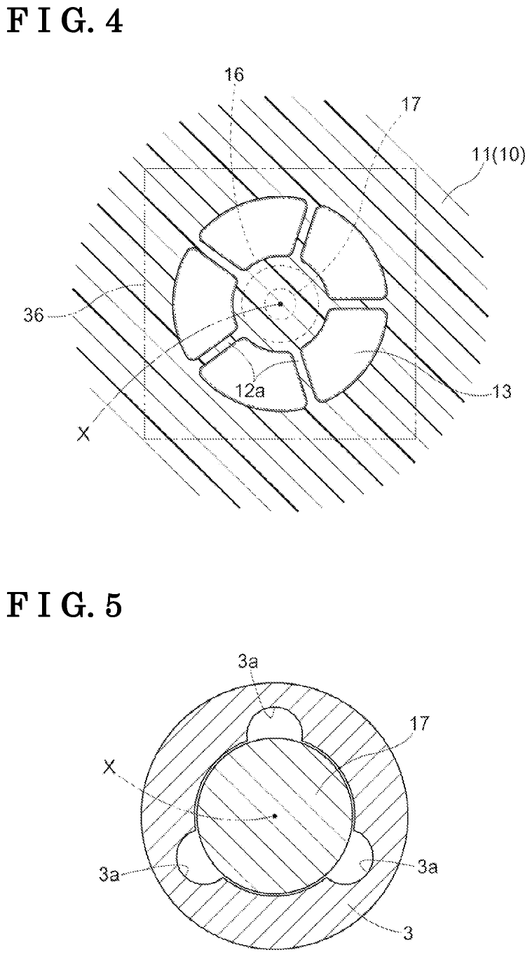

(a) As illustrated in FIGS. 3 and 4, the main housing 10 is configured by using the heat conduction wall 13 provided with a circular-shaped hole portion formed at the center. The bottom portion 12 is formed by insert molding such that the heat conduction wall 13 including the hole portion is fixed to the wall portion 11. The main housing 10 includes a plurality of frame portions 12a provided at the outer surface of the heat conduction wall 13. The frame portions 12a correspond to ribs arranged in a radial fashion of which the center is the axis X in such a manner that the ribs connect the support portion 16 and the main housing 10 to each other. Accordingly, the support portion 16 is arranged in the hole portion formed at the center of the heat conduction wall 13 and the support portion 16 is retained therein, when the main housing 10 is formed.

The heat release sheet 36 is sandwiched or interposed between the outer surface of the heat conduction wall 13 and the control substrate 35 also in the other embodiment (a). Even though the frame portions 12a exist at the outer side of the heat conduction wall 13, the heat release sheet 36 goes into or enters between the plural frame portions 12a because the heat release sheet 36 is flexible as described in the aforementioned embodiment. Consequently, the heat release sheet 36 is in contact with the outer surface of the heat conduction wall 13, thereby realizing a favorable heat conduction.

In the other embodiment (a), the heat conduction wall 13 is inserted when the main housing 10 is formed, and thus a process of attaching the heat conduction wall 13 does not need to be provided separately. The support portion 16 is also inserted, and thus another process of providing the support portion 16 at the heat conduction wall 13 does not need to be set separately.

(b) As illustrated in FIG. 5, plural grooves 3a each of which is formed in a lengthwise direction (the direction along the axis X) are provided at an inner periphery of the cylindrical body 3. The grooves 3a allow the cooling water to flow therein. By providing the grooves 3a instead of or in addition to the water transmitting hole 5, the grooves 3a allows the cooling water to flow from the position close to the heat conduction wall 13 towards the impellers 2c as the pump rotor 2 rotates, in a similar manner to the water transmitting hole 5 of the aforementioned embodiment.

(c) The heat conduction wall 13 and the shaft 17 are formed to be integral with each other. As an example, a configuration is conceivable in which the shaft 17 made of metal and the heat conduction wall 13 made of metal are formed in a manner that the shaft 17 is fixed to the heat conduction wall 13. By forming the shaft 17 integrated with the heat conduction wall 13, a position of the axis X is determined and a rotating posture of the motor rotor 1 is stabilized.

(d) A posture of the control substrate 35 is set such that the electric power control element 35a faces or opposes the outer side of the heat conduction wall 13, and the heat release sheet 36 is sandwiched or interposed between the electric power control element 35a and the heat conduction wall 13. According to this configuration, the heat of the electric power control element 35a may be released directly.

The present disclosure is applicable to an electric pump configured to transmit or send fluid.

According to the aforementioned embodiment, the water pump P includes the main housing 10 including the bottomed cylindrical shape having the bottom portion 12 and the opening portion provided at the opposite side to the bottom portion 12, the motor rotor 1 rotatably accommodated in the main housing 10 and including the permanent magnet 4, the field coil 15 formed integrally with the main housing 10 and configured to apply a magnetic field to the permanent magnet 4, the pump rotor 2 provided an the outside of the opening portion of the main housing 10 and configured to transmit the cooling water by being rotated by the driving force of the motor rotor 1, and an control substrate 35 provided at the outside of the bottom portion 12 of the main housing 10 and configured to control the electric current to be supplied to the field coil 15. The bottom portion 12 includes the heat conduction wall 13 formed of the material including the heat conductivity which is higher than the heat conductivity of the main housing 10. The main housing 10 includes the motor rotor space portion 10S in which the motor rotor 1 is accommodated. The motor rotor space portion 10S is formed with the flow path configured to allow the cooling water to flow into the motor rotor space portion 10S from the opening portion, and allow the cooling water to flow out of the motor rotor space portion 10S from the opening portion after the cooling water is in contact with the inner surface of the heat conduction wall 13. The control substrate 35 is arranged to be positioned along the outer surface of the heat conduction wall 13.

According to the above-described configuration, the heat conduction wall 13 of the bottom portion 12 of the main housing 10 is formed with the material having the high heat conductivity, including metal plate, for example, and the control substrate 35 is arranged along the heat conduction wall 13, and thus the heat of the control substrate 35 may be transmitted to the heat conduction wall 13 by the radiation and/or air convection. By flowing the cooling water from the opening portion of the main housing 10 in a manner that the cooling water is in contact with the heat conduction wall 13, the heat of the heat conduction wall 13 is removed by the cooling water. As a result, the heat release of the control substrate 35 is enabled. According to the above-described configuration, no parts or components are arranged in a gap formed between an inner periphery of the main housing 10 and an outer periphery of the motor rotor 1, and thus the gap between the inner periphery of the main housing 10 and the outer periphery of the motor rotor 1 can be reduced, thereby maintaining a performance of the water pump P high. Consequently, the water pump P, which is highly efficient and which utilizes the effectiveness enabling the heat release of the control substrate 35 due to the cooling water flowing from the pump rotor 2 to the inner portion of the main housing 10, is configured.

According to the aforementioned embodiment, the water pump P includes the heat release sheet 36 arranged between the control substrate 35 and the heat release sheet 36, and the heat release sheet 36 is flexible and heat conductive.

According to the above-described configuration, the high heat release effect can be obtained by transferring the heat of the control substrate 35 to the heat conduction wall 13 via the heat release sheet 36. For example, in a configuration in which a space portion is formed between the control substrate 35 and the heat conduction wall 13, the heat may be released by radiation and/or air convection. With the use of the heat release sheet 36, however, the heat of the control substrate 35 is allowed to be transferred to the heat conduction wall 13 by the thermal conduction. Even though some protrusions are formed at the control substrate 35, the heat release sheet 36 is in contact with the control substrate 35 at a large area and the heat conduction is allowed because the heat release sheet 36 includes flexibility.

According to the aforementioned embodiment, the motor rotor 1 is rotatably supported by the shaft 17 and the end portion of the shaft 17 is supported by the support portion 16. The support portion 16 is formed integrally with the heat conduction wall 13.

According to the above-described configuration, the end portion of the shaft 17 is supported by the support portion 16 formed integrally with the heat conduction wall 13, and thus a posture of the shaft 17 is stabilized, thereby allowing the motor rotor 1 to rotate stably.

According to the aforementioned embodiment, the motor rotor 1 is rotatably supported by the shaft 17 formed integrally with the heat conduction wall 13.

According to the above-described configuration, the shaft 17 is provided integrally with the heat conduction wall 13, and thus the posture of the shaft 17 is stabilized, thereby allowing the motor rotor 1 to rotate stably.

According to the aforementioned embodiment, the inner surface of the heat conduction wall 13 is provided with the protrusion-and-recess portion 13a formed at least in a region with which the cooling water is in contact.

According to the above-described configuration, the protrusion-and-recess portion 13a is provided at the region of the inner surface of the heat conduction wall 13, the region with which the cooing water is in contact. Consequently, the area of the surface with which the cooling water is in contact increases, thereby allowing the heat release of the heat conduction wall 13 to be performed satisfactorily.

According to the aforementioned embodiment, the control substrate 35 includes the other substrate surface (i.e., a facing surface) that is flat, and the heat conduction wall 13 includes an outer surface (i.e., a facing surface) that is flat and faces the other substrate surface of the control substrate 35. The other substrate surface of the control substrate 35 and the outer surface of the heat conduction wall 13 are in postures in which these surfaces are parallel with each other, and the heat release sheet 36 is sandwiched between the control substrate 35 and the heat conduction wall 13.

According to the above-described configuration, the other substrate surface of the control substrate 35 and the outer surface of the heat conduction wall 13, which face each other, are flat and parallel with each other. Consequently, the heat release sheet 36 including a constant thickness or even thickness may be used, and thus the configuration is simplified.

The principles, preferred embodiments and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An electric pump comprising:
a housing including a bottomed cylindrical shape having a bottom portion and an opening portion provided at an opposite side to the bottom portion;
a motor rotor rotatably accommodated in the housing and including a permanent magnet;
a field coil formed integrally with the housing and configured to apply a magnetic field to the permanent magnet;
a pump rotor provided at an outside of the opening portion of the housing and configured to transmit fluid by being rotated by a driving force of the motor rotor;
a control substrate provided at an outside of the bottom portion of the housing and configured to control an electric current to be supplied to the field coil;
the bottom portion including a heat conduction wall formed of material including heat conductivity which is higher than heat conductivity of the housing;
the housing including a space portion in which the motor rotor is accommodated, the space portion being formed with a flow path configured to allow the fluid to flow into the space portion from the opening portion, and allow the fluid to flow out of the space portion from the opening portion after the fluid is in contact with an inner surface of the heat conduction wall; and
the control substrate being arranged to be positioned along an outer surface of the heat conduction wall.

2. The electric pump according to claim 1, comprising:
a heat release sheet arranged between the control substrate and the heat release sheet, the heat release sheet being flexible and heat conductive.

3. The electric pump according to claim 1, wherein the motor rotor is rotatably supported by a shaft and an end portion of the shaft is supported by a support portion, and
the support portion is formed integrally with the heat conduction wall.

4. The electric pump according to claim 2, wherein the motor rotor is rotatably supported by a shaft and an end portion of the shaft is supported by a support portion, and
the support portion is formed integrally with the heat conduction wall.

5. The electric pump according to claim 1, wherein the motor rotor is rotatably supported by a shaft formed integrally with the heat conduction wall.

6. The electric pump according to claim 2, wherein the motor rotor is rotatably supported by a shaft formed integrally with the heat conduction wall.

7. The electric pump according to claim 1, wherein the inner surface of the heat conduction wall is provided with a protrusion-and-recess portion formed at least in a region with which the fluid is in contact.

8. The electric pump according to claim 2, wherein the inner surface of the heat conduction wall is provided with a protrusion-and-recess portion formed at least in a region with which the fluid is in contact.

9. The electric pump according to claim 3, wherein the inner surface of the heat conduction wall is provided with a protrusion-and-recess portion formed at least in a region with which the fluid is in contact.

10. The electric pump according to claim 4, wherein the inner surface of the heat conduction wall is provided with a protrusion-and-recess portion formed at least in a region with which the fluid is in contact.

11. The electric pump according to claim 2, wherein
the control substrate includes a facing surface that is flat, and the heat conduction wall includes a facing surface that is flat and faces the facing surface of the control substrate,
the facing surface of the control substrate and the facing surface of the heat conduction wall are in postures in which the facing surfaces are parallel with each other, and
the heat release sheet is sandwiched between the control substrate and the heat conduction wall.
